(19) United States
(12) Patent Application Publication
(10) Pub. No.: US 2026/0354339 A1
(43) Pub. Date: Nov. 12, 2026

(54) MODULAR GROOMING DOOR SYSTEM FOR EQUINE CARE

(71) Applicant: Improve Equine Inc., Land O Lakes, FL (US)

(72) Inventor: Sara Kirkwood, Land O Lakes, FL (US)

(73) Assignee: Improve Equine Inc., Land O Lakes, FL (US)

(21) Appl. No.: 19/205,309

(22) Filed: May 12, 2025

(51) Int. Cl. A01K 1/00; A01K 1/06; A01K 5/00; A01K 13/00

(52) U.S. Cl. CPC A01K 1/0017; A01K 1/0613; A01K 5/008; A01K 13/00

(57) ABSTRACT

An modular grooming door system for equine care includes a rectangular frame that slides along a track system within a stable aisle, secured by drop rods. The horse-facing side features an adjustable blocker tie, a bar insert allowing restricted head movement, and an O-ring attachment for a hay net or feed bucket to provide forage access. The aisle-facing side includes a collapsible saddle rack and bridle rack for handler convenience. The system bolts into place and slides aside when not in use, preserving aisle space. By enabling head movement and forage access, the grooming door system reduces horse stress during grooming, promoting equine welfare while maintaining functionality for handlers.

### BACKGROUND OF THE INVENTION

### Field of the Invention

The present invention relates to equine care systems, specifically to a modular grooming door system designed to enhance horse welfare by reducing stress during grooming, tacking, or veterinary procedures while providing functional storage and accessibility for handlers.

### Description of the Related Art

Traditional equine grooming setups, such as cross-ties or fixed tethering systems, restrain horses during grooming, tacking, or veterinary care. These systems often limit natural movement, causing stress and contributing to health issues like gastric ulcers. Modern equine care emphasizes empathetic, science-based approaches, prioritizing freedom of movement, forage access, and stress reduction.

Existing grooming solutions lack modularity, customization, and welfare-focused features, such as adjustable tethering or integrated forage systems, that align with contemporary standards. There is a need for a grooming system that integrates the practicality of traditional setups with innovations that promote horse comfort, reduce anxiety, and adapt to diverse stable environments. The present invention addresses these needs by providing a modular grooming door system with adjustable, stress-reducing components and handler-oriented storage solutions.

### SUMMARY OF THE INVENTION

The modular grooming door system for equine care enhances horse welfare by minimizing stress during grooming while ensuring handler efficiency. The system features a frame, constructed from durable materials like powder-coated steel or aluminum, which slides along a track system in a stable aisle and is secured by drop rods. The horse-facing side includes an adjustable blocker tie with a spring-loaded, quick-release mechanism, a bar insert for restricted head movement, and an O-ring attachment for a hay net or feed bucket to provide forage access. The aisle-facing side offers a collapsible saddle rack, bridle rack, hooks, and baskets for storing grooming tools and supplies. Replacing traditional cross-ties, the system allows horses to move their heads within a safe range, reducing anxiety and supporting gut health through forage access. When not in use, the frame slides to a stored position, preserving aisle space. Optional enhancements, such as automated sliding mechanisms, flexible mesh inserts, or stress-monitoring sensors, increase adaptability for various stable settings.

The invention uniquely combines traditional equine restraint functionality with modern welfare considerations, including stress regulation, modularity, and customization. Its adjustable components and handler-focused design provide a novel solution for equine facilities balancing horse comfort with operational efficiency.

The foregoing summary has been provided to introduce a selection of concepts in a simplified form that are further described below in the detailed description. The summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of the modular grooming door system in its deployed position within a stable aisle, as shown from the aisle side;

FIG. 2 is a perspective view of the horse-facing side, showing the adjustable blocker tie, bar insert, and O-ring attachment;

FIG. 3 is a perspective view of the aisle-facing side, illustrating exemplary collapsible saddle rack, bridle rack, hooks, and baskets, as well as the track system upon which the grooming door system slides into place;

FIG. 4 is an additional view of the grooming door components from the horse side, including a hay net for forage;

FIG. 5 is a close up view of the lower portion of the grooming door, showing a drop rod with mounting hardware for securing the door in position;

FIG. 6 is an additional perspective view showing the adjustable blocker tie with its quick-release clip;

FIG. 7A is an additional perspective view, illustrating the adjustable bar insert for accommodating different horse sizes as shown with a top board positioned in a high location;

FIG. 7B is an additional perspective view, illustrating the adjustable bar insert for accommodating different horse sizes as shown with a top board positioned in a lower location; and

FIG. 7C is an additional perspective view, illustrating a plurality of adjustable bar inserts with two top boards positioned in in both high and lower locations.

### DETAILED DESCRIPTION OF THE DRAWINGS

The exemplary embodiments described herein in detail for illustrative purposes are subject to many variations in structure and design. It should be emphasized, however, that the present disclosure is not limited to a particular equine grooming door system as shown and described. It is understood that various omissions and substitutions of equivalents are contemplated as circumstances may suggest or render expedient, but these are intended to cover the application or embodiments without departing from the spirit or scope of the claims of the present disclosure. Also, it is to be understood that the phraseology and terminology used herein are for the purpose of description and should not be regarded as limiting.

The modular grooming door system for equine care, as depicted in the accompanying drawings, provides an innovative solution for enhancing horse welfare during grooming while optimizing handler efficiency. The system integrates adjustable, stress-reducing features with modular storage and a slidable frame, suitable for equine stables. The following description refers to the drawings, which illustrate the preferred embodiment and its components in various views to fully disclose the invention's structure and operation, with reference numbers corresponding to labeled elements in the formal drawings.

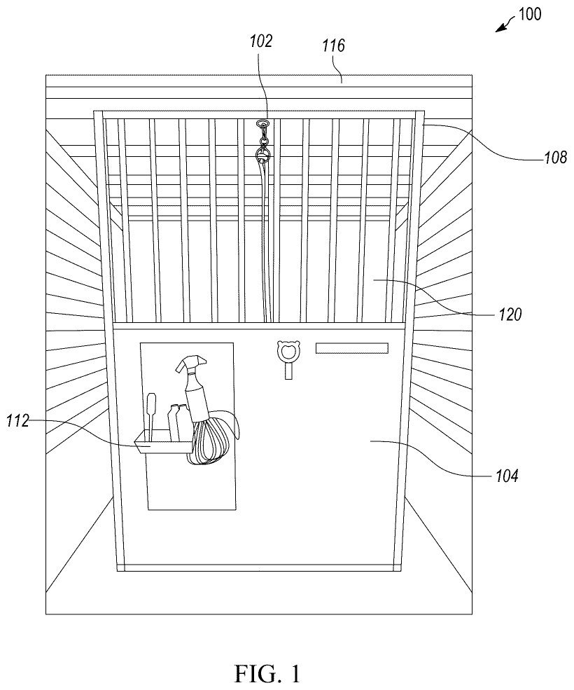

FIG. 1 illustrates a perspective view of the modular grooming door system (100) deployed across a stable aisle. The system comprises a frame (108), constructed in one exemplary embodiment from powder-coated 6061-T6 aluminum alloy or A36 steel with a corrosion-resistant epoxy powder coating, ensuring durability in humid stable environments. The frame (108) measures approximately 4 feet wide by 7 feet tall, with a dimensional tolerance of ±0.25 inches to ensure consistent fit within standard stable aisles (typically 8-12 feet wide).

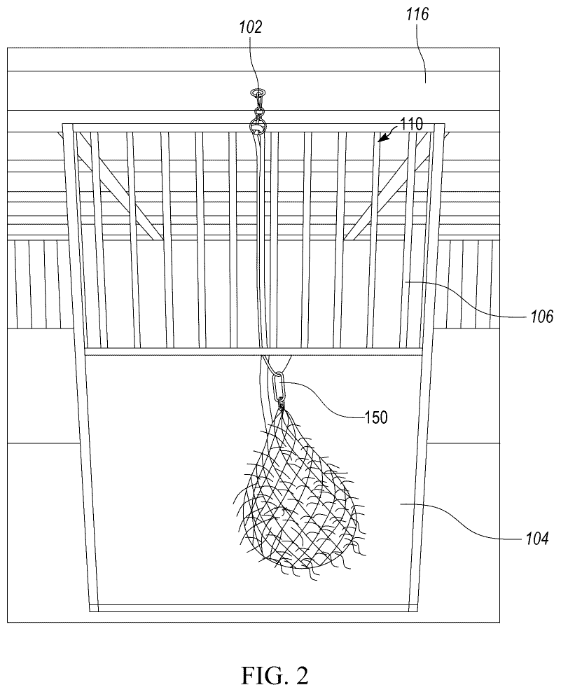

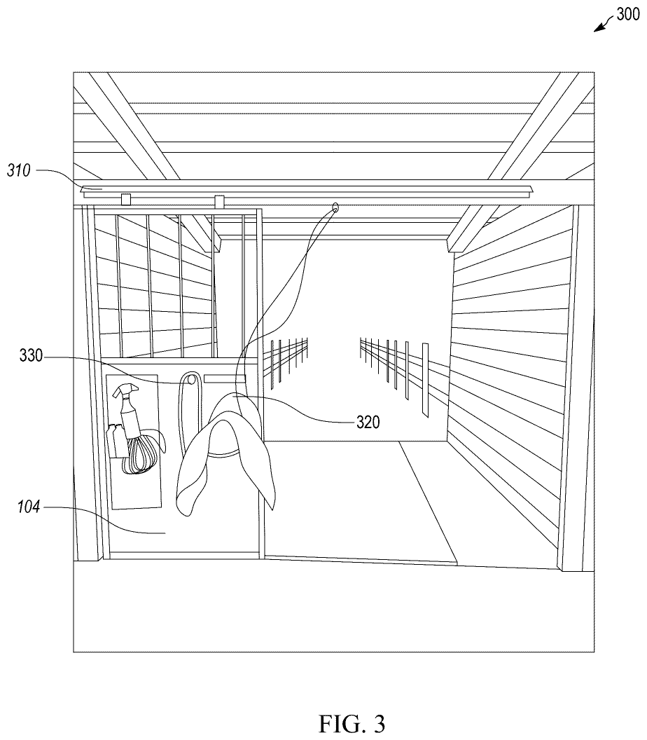

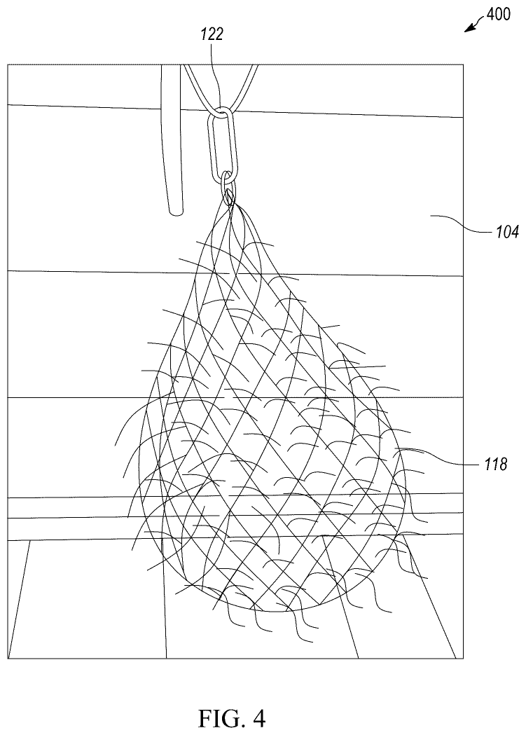

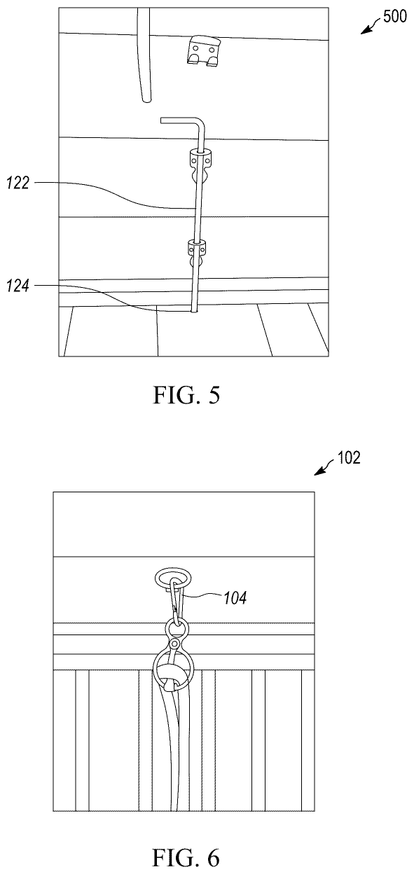

The frame (108) is mounted on a track system (310, FIG. 3), which again, in one exemplary embodiment, consists of a stainless steel rail (e.g., 304 stainless) and nylon or bronze rollers with a diameter of 1.5 inches±0.05 inches, affixed to the stable floor or an adjacent stall wall. This allows the frame (108) to slide laterally with a maximum frictional resistance of 10 pounds-force. The frame (108) is secured by four drop rods (122, FIG. 5), each 0.75 inches in diameter and fabricated from galvanized steel, inserted into receptacles with a clearance fit of 0.01 inches. The horse-facing side features a bar insert (106, FIG. 2) with bars spaced 2 to 8 inches apart (±0.1 inches) on an equidistant (120) basis, an adjustable overhead blocker tie (102) attached to an overhead block (116), and an O-ring attachment (150) on a bottom board (104) for a hay net (118, FIG. 4) or feed bucket. The aisle-facing side includes a collapsible saddle rack (320) and a bridle rack (330). Welds joining frame components adhere to AWS D1.1 standards, ensuring structural integrity under loads up to 500 pounds. This view highlights the system's seamless integration into a stable aisle, balancing equine comfort and handler access.

FIG. 2 provides a perspective view of the horse-facing side, emphasizing welfare-enhancing components. The bar insert (110), centrally positioned within the frame (108, FIG. 1), consists of 1-inch diameter aluminum bars, either vertically or horizontally arranged, with a spacing of 2 to 8 inches (±0.1 inches) to allow the horse's head to extend through while restricting lateral movement. The bars are anodized for corrosion resistance and have a surface roughness of Ra 1.6 μm to ensure smoothness. The bar insert (110) is mounted on a sliding mechanism with a linear bearing system, providing vertical adjustment over a 24-inch range (±0.05 inches) to accommodate horses from 10 to 18 hands in height.

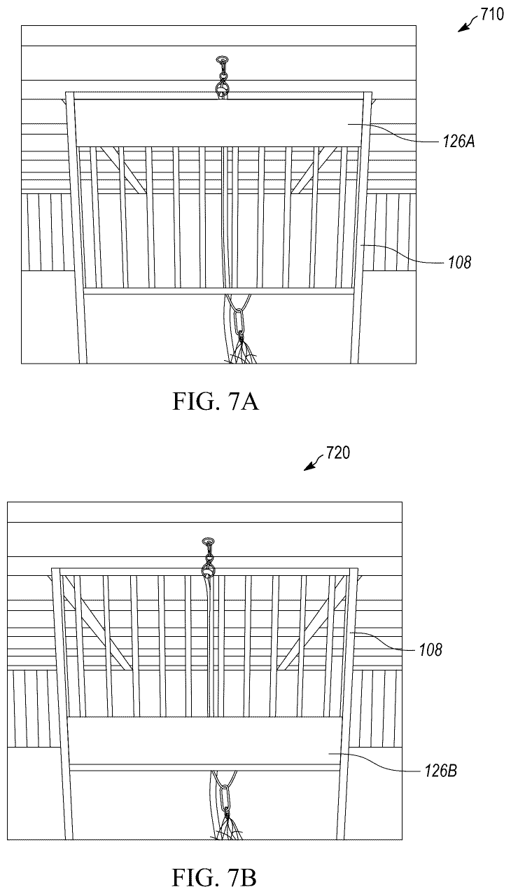

The overhead block (116), a 2-inch-thick aluminum or hardwood plank, supports the adjustable blocker tie (102), a 1-inch diameter nylon rope or polyester strap with a tensile strength of 1,000 pounds. The blocker tie (102) includes a quick-release clip (104) and spring-loaded mechanism. This mechanism is further shown in detail in FIG. 6.

The bottom board (104), similar in construction to the top board but uniformly solid adross the frame 100, supports an O-ring attachment (150), a 2-inch diameter stainless steel ring welded with a fillet weld (AWS D1.1). The O-ring (150) secures a hay net (118), capable of holding one small flake of hay (approximately 2-3 pounds), or a feed bucket. The hay net (118) is woven from UV-resistant polyethylene with a mesh size of 1.5 inches. This view underscores the system's focus on equine comfort through precise engineering of tethering and forage components.

FIG. 3 depicts an additional perspective view of the aisle-facing side, highlighting handler-oriented features, as the door system 100 is slid into storage along track 310. The frame (108) supports a collapsible saddle rack (320), constructed from 1.5-inch square aluminum tubing with a wall thickness of 0.125 inches (±0.01 inches). The saddle rack (320) pivots on stainless steel hinges, folding flat with a maximum angle of 90 degrees and a positional tolerance of ±1 degree. It adjusts vertically over a 12-inch range and horizontally to accommodate saddle widths from 12 to 20 inches. The bridle rack (330) comprises four 0.5-inch diameter stainless steel hooks, each with a load capacity of 20 pounds, spaced 6 inches apart (±0.1 inches).

Additional hooks and baskets (112, FIG. 1), fabricated from powder-coated steel wire with a 0.25-inch diameter, provide storage for grooming tools (e.g., brushes, hoof picks) and supplies (e.g., bandages). The baskets (112) have a volume of approximately 0.5 cubic feet and a load capacity of 15 pounds. The drop rods (122, FIG. 5), extend into receptacles (124, FIG. 5) with a depth of 2 inches (±0.05 inches). All components are secured with bolts or welds meeting ASTM A325 standards, ensuring stability under dynamic loads from handler activity. This view demonstrates the system's efficiency in organizing equipment within a compact footprint.

FIG. 4 presents is an additional view of the grooming door components (400) from the horse side, including a hay net (118) for forage that is attached using the O-ring attachment (122) as shown. With FIG. 4 in mind, and returning again to FIGS. 2 and 3, the frame (108) is suspended using the track system (310), with a rail length in one exemplary embodiment of 8 feet (±0.5 inches) and rollers spaced 12 inches apart.

Turning to FIG. 5, which illustrates a close up view of the bottom portion (500) of the door system (100), a plurality of drop rods (122) may be implemented with a length in one exemplary embodiment of 6 inches (±0.1 inches) and featuring a chamfered end for ease of insertion. The bar insert (110) includes mounting brackets with a slot tolerance of ±0.02 inches for vertical adjustment.

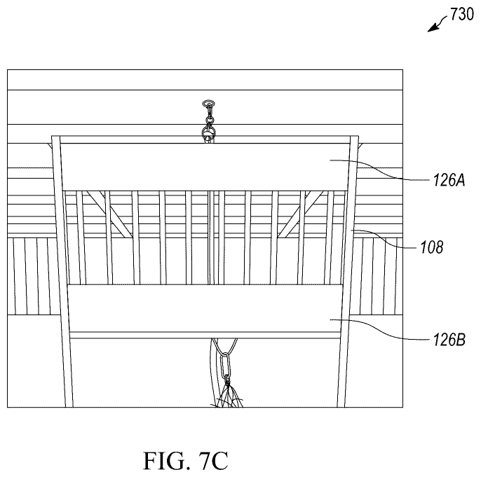

In one exemplary embodiment, and referring now to FIGS. 7A-7C, the top board (126A) and additional top board (126B) are 48 inches long (±0.25 inches), with pre-drilled holes for the blocker tie (102) and in one embodiment, an O-ring attachment (150). The blocker tie's rope or strap is secured with a stainless steel carabiner, and the O-ring (150) is welded with a 0.25-inch fillet.

The aisle-facing components—saddle rack (320), bridle rack (330), hooks and baskets (122)—are shown with mounting brackets using 0.375-inch diameter bolts. An optional automated sliding mechanism, or track system (310), comprising a 24V DC electric motor with a torque of 50 Nm, may integrate with the track system (310). All components are designed for assembly with standard tools, with tolerances ensuring interchangeability across units. This view clarifies the system's modularity and ease of maintenance.

In one embodiment (not depicted) the grooming door system can be placed into a stored position, slid aside to preserve aisle space. The frame (108) is positioned parallel to a stall wall, with the track system (310) extended to a length of 8 feet. The drop rods (122) are retracted or removed, allowing the frame (108) to slide with a maximum force of 10 pounds. The saddle rack (320) and bridle rack (330) are folded flat, reducing the frame's depth to 6 inches (±0.5 inches). The horse-facing side, including the bar insert (110) and O-ring attachment (150), is unobtrusive, maintaining a clear aisle width of at least 6 feet. The frame's alignment is maintained by guide rollers with a positional tolerance of ±0.1 inches. This view highlights the system's space-saving design, critical for high-traffic stables.

In one embodiment, the adjustable bar insert (110) can be positioned in multiple configurations for different horse sizes. The insert (110), for example can be positioned in a high position (48 inches from the frame base, ±0.5 inches) for draft horses, a middle position (36 inches) for average horses, and a low position (24 inches) for ponies or minis. Adjustment is achieved via a rack-and-pinion mechanism with a pitch of 0.25 inches, ensuring precise positioning. The bars, with a length of 36 inches (±0.1 inches), are spaced to maintain structural rigidity under a 200-pound lateral load. An optional flexible mesh material (126), woven from 0.125-inch diameter nylon cord with a 1-inch mesh size, may replace the bars, offering a tensile strength of 500 pounds. As previously stated, the insert may be adapted to a specific breed of a horse's head through the insert (110), demonstrating alignment with the horse's withers. This view emphasizes the system's adaptability to diverse equine sizes.

FIGS. 7A, 7B, and 7C further detail the adjustable blocker tie (102) and its tension adjustment system. FIG. 7A shows a perspective view (710) where top board (126A) is secured at the top of the system 100 where the blocker tie (102) is attached to the top board (126A), featuring a quick-release clip (e.g., 104, FIG. 6) constructed from stainless steel with a breaking strength of 1,200 pounds. The clip (104), in one embodiment, releases under a force of 300 pounds (±10 pounds) to prevent injury.

FIG. 7B provides an additional perspective view (720) where the top board (126B) is secured at the bottom of the system 100 so the O-ring 150 attaches to the grooming door system 100 at the appropriate height. While not depicted, in one embodiment, the spring-loaded system incorporating portions of blocker tie 102 comprises a 2-inch diameter stainless steel spring, as one of ordinary skill in the art will appreciate, with a spring constant of 50 N/mm, housed in an aluminum casing. In this configuration, the spring allows the tie (102) to extend up to 12 inches under tension, reducing panic during pull-back events.

FIG. 7C offers an additional perspective view (730) of the blocker tie assembly (102, 730), showing the clip and spring integration with top boards (126A) and top boards (126B) as shown. Optional sensors (not depicted), such as piezoelectric strain gauges or infrared heart rate monitors, and again as one of ordinary skill in the art will appreciate, may be embedded near the tie (102), with a sensitivity of 0.1% strain or 1 bpm, to alert handlers to stress indicators. These views highlight the system's innovative tethering mechanism, engineered for safety and precision.

The drawings collectively depict a modular grooming door system that integrates traditional equine restraint with welfare-focused features, supported by precise materials and tolerances. Variations may include composite polymer frames or additional sensors, with all components designed for durability and ease of use in stable environments.

In one exemplary embodiment, the modular grooming door system for equine care enhances horse welfare by reducing stress during grooming while maintaining handler convenience. The preferred embodiment, as shown in FIGS. 1-7C, comprises a frame (108) of powder-coated 6061-T6 aluminum or A36 steel, measuring 4 feet wide by 7 feet tall (±0.25 inches), mounted on a track system (310) with stainless steel rails and nylon rollers. Four drop rods (122) of galvanized steel secure the frame (108) in a deployed position.

The horse-facing side includes a bar insert (110) with 1-inch diameter aluminum bars, spaced 2 to 8 inches apart, adjustable over a 24-inch range to suit horses from 10 to 18 hands. An adjustable blocker tie (102), a 1-inch nylon rope with a quick-release clip and spring-loaded system (730), is attached to a 2-inch-thick top board (126A, 126B). An O-ring attachment (150) on a bottom board (104) secures a hay net (118) holding 2-3 pounds of hay. The aisle-facing side features a collapsible saddle rack (320), adjustable for 12-20-inch saddles, a bridle rack (330) with four hooks, and hooks and baskets (112) for tools and supplies.

When not in use, the frame (100) slides to a stored position (e.g., 300), with racks (320, 330) folded flat. Optional features include an automated sliding mechanism with a 24V DC motor, a flexible mesh insert, and sensors (not depicted) for stress monitoring. The system may be adapted for other livestock with modified dimensions.

In operation, a handler slides the frame (108) into position, secures it with drop rods (122), tethers the horse to the blocker tie (102), adjusts the bar insert (110), and attaches a hay net (118). After grooming, the frame (108) is stored, preserving aisle space. The system promotes equine welfare through head movement and forage access while enhancing handler efficiency.

The foregoing descriptions of specific embodiments of the present disclosure have been presented for purposes of illustration and description. They are not intended to be exhaustive or to limit the present disclosure to the precise forms disclosed, and of course, many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present disclosure.

It should be noted that, as used herein, the terms “an embodiment,” “embodiment,” “embodiments,” “the embodiment,” “the embodiments,” “one or more embodiments,” “some embodiments,” and “one embodiment” mean “one or more (but not all) embodiments of the present invention(s)” unless expressly specified otherwise.

The terms “including,” “comprising,” “having” and variations thereof mean “including but not limited to,” unless expressly specified otherwise.

The enumerated listing of items does not imply that any or all of the items are mutually exclusive, unless expressly specified otherwise.

The terms “a,” “an” and “the” mean “one or more,” unless expressly specified otherwise.

The foregoing descriptions of specific embodiments of the present disclosure have been presented for purposes of illustration and description. They are not intended to be exhaustive or to limit the present disclosure to the precise forms disclosed, and of course, many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present disclosure.

What is claimed is:

1. A modular grooming door system for equine care, comprising:
a frame configured to slide along a track system within a stable aisle;
one or more drop rods configured to secure the frame in a deployed position;
a horse-facing side comprising an adjustable blocker tie, a bar insert allowing restricted head movement for a horse, and an O-ring attachment; and
an aisle-facing side comprising one or more collapsible racks;
wherein the modular grooming door system is configured to reduce stress in horses by allowing head movement and providing forage access during grooming.

2. The modular grooming door system of claim 1, wherein the adjustable blocker tie is attached through a top board of the rectangular frame.

3. The modular grooming door system of claim 1, wherein the O-ring attachment is secured to a bottom board of the rectangular frame for providing forage.

4. The modular grooming door system of claim 1, wherein the bar insert comprises a plurality of bars spaced to allow the horse to extend its head through the bar insert while preventing the horse from turning around, the bars being integrated into the rectangular frame.

5. The modular grooming door system of claim 4, wherein the plurality of bars of the bar insert are arranged vertically.

6. The modular grooming door system of claim 4, wherein the plurality of bars of the bar insert are arranged horizontally.

7. The modular grooming door system of claim 4, wherein the bar insert is vertically adjustable to accommodate a plurality of types, sizes and shapes of horses.

8. The modular grooming door system of claim 1, wherein the adjustable blocker tie includes a spring-loaded system configured to vary secure levels, allowing the blocker tie to extend under tension if the horse pulls back, thereby minimizing panic.

9. The modular grooming door system of claim 1, wherein the hay net attached to the O-ring attachment is configured to hold approximately one small flake of hay to buffer the horse's gut during grooming.

10. The modular grooming door system of claim 1, wherein the rectangular frame is constructed from powder-coated steel or aluminum to withstand stable environments.

11. The modular grooming door system of claim 1, wherein the rectangular frame slides laterally to a stored position adjacent to or in front of a stable stall when not in use, preserving pass-through space in the stable aisle.

12. The modular grooming door system of claim 1, wherein the aisle-facing side further comprises hooks for hanging grooming tools.

13. The modular grooming door system of claim 1, wherein the aisle-facing side further comprises baskets for storing bandages or grooming supplies.

14. The modular grooming door system of claim 1, wherein the one or more collapsible racks further comprises one of a collapsible saddle rack adjustable to accommodate different saddle sizes and a collapsible bridle rack adjustable to accommodate different bridle sizes.

15. The modular grooming door system of claim 1, further comprising an automated sliding mechanism powered by an electric motor to move the rectangular frame along the track system.

16. The modular grooming door system of claim 1, wherein the bar insert is replaced with a flexible mesh material to allow restricted head movement while enhancing safety.

17. The modular grooming door system of claim 1, further comprising a sensor integrated into the horse-facing side to monitor horse stress levels and alert a handler to potential issues.

18. The modular grooming door system of claim 1, wherein the spacing between said plurality of vertical bars is between 2 and 8 inches.

19. A grooming door system for equine care comprising:
a frame configured to be movably positioned within a stable aisle; and
a horse-facing side comprising a tethering element and a head-restricting element allowing restricted head movement for a horse, and a forage attachment for providing forage access; wherein the grooming door system is configured to reduce stress in horses by allowing head movement and providing forage access during grooming.

20. A modular grooming door system for equine care comprising:
a rectangular frame constructed from powder-coated steel or aluminum, the frame configured to slide along a track system within a stable aisle;
a plurality of drop rods configured to secure the frame in a deployed position;
a horse-facing side comprising an adjustable blocker tie attached through a top board of the rectangular frame, the adjustable blocker tie including a quick-release clip with a tension adjustment system configured to vary secure levels, allowing the blocker tie to release or loosen if the horse pulls back, thereby minimizing panic, a bar insert comprising a plurality of vertically arranged bars spaced to allow the horse to extend its head through the bar insert while preventing the horse from turning around, the bar insert being vertically adjustable to accommodate horses of different sizes, and an O-ring attachment secured to a bottom board of the rectangular frame for attaching a hay net configured to hold approximately one small flake of hay; and
an aisle-facing side comprising a collapsible saddle rack, a bridle rack, hooks for hanging grooming tools, and baskets for storing bandages or grooming supplies; wherein the modular grooming door system is configured to reduce stress in horses by allowing head movement and providing forage access during grooming.
